(19) United States
(12) Patent Application Publication
(10) Pub. No.: US 2009/0211249 A1
(43) Pub. Date: Aug. 27, 2009

(54) INSTALLATION FOR GENERATING ELECTRICAL ENERGY FROM SOLAR ENERGY

(75) Inventors: Michel Wohrer, Neuilly Sur Seine (FR); Pierre Laffitte, Saint Paul (FR); Christian Lenotre, Le Bar Sur Loup (FR)

Correspondence Address: YOUNG & THOMPSON, 209 Madison Street, Suite 500, ALEXANDRIA, VA, 22314, US

(73) Assignee: SOPHIA ANTIPOLIS ENERGIE DEVELOPPEMENT, Valbonne (FR)

(21) Appl. No.: 12/393,245

(22) Filed: Feb. 26, 2009

(30) Foreign Application Priority Data
Feb. 27, 2008 (FR) 08 51261

(51) Int. Cl. F03G 6/00; F24J 2/04; F01K 23/00; F01K 13/00

(52) U.S. Cl. 60/641.8; 126/640; 60/670; 60/645

(57) ABSTRACT

An installation for generating electrical energy from solar energy, includes:
a hot source (2),
a cold source (4),
a heat machine (5) for producing electricity using the hot source (2) and the cold source (4);
the hot source (2) including:
elements (6) for heating a first heat-exchange fluid (8) using solar energy,
elements (10) for storing thermal energy,
a first transport circuit (12) for the first heat-exchange fluid (8) connecting the heating elements (6), the storage means (10) and the heat machine (5) for producing electricity; the cold source (4) including a second transport circuit (46) for a second heat-exchange fluid (48); wherein the storage elements (10) use the latent fusion heat of a phase change material (18).

### FIELD OF THE INVENTION

The present invention relates to an installation for generating electrical energy from solar energy, of the type comprising:
a hot source,
a cold source,
a heat machine for producing electricity, using the hot source and the cold source;

the hot source comprising:
means for heating a first heat-exchange fluid using solar energy,
means for storing thermal energy,
a first transport circuit for the first heat-exchange fluid connecting the heating means, the storage means and the heat machine for producing electricity;

the cold source comprising a second transport circuit for a second heat-exchange fluid.

### BACKGROUND OF THE INVENTION

Document FR 2 874 975 A1 describes a low-temperature solar device for producing electricity. The device uses solar captors in order to obtain hot water during the day and heat sinks in order to obtain cold water during the night. The hot water is stored in a container in order to have permanently a hot source which serves to produce electricity using a turbine in a Rankine cycle, connected to an alternator.

However, water, with sensible heat, does not allow provision of a storage temperature which is substantially constant and the storage density of hot caloric energy is not at an optimum level.

Therefore, an object of the invention is to increase the storage density of hot caloric energy at a substantially constant temperature in order to optimise the operation of the installation for generating electrical energy.

### SUMMARY OF THE INVENTION

To that end, the invention relates to an installation for generating electrical energy from solar energy of the above-mentioned type, characterised in that the storage means use the latent fusion heat of a phase change material.

According to other embodiments, the installation for generating electrical energy comprises one or more of the following features, taken in isolation or in accordance with any technically possible combination:
the storage means comprise a vessel and a plurality of sealed capsules which are arranged in the vessel, the first heat-exchange fluid flowing in the vessel between the sealed capsules, the sealed capsules comprising the phase change material,
the fusion temperature of the phase change material is between 100° Celsius and 130° Celsius,
the phase change material is an organic material,
the organic material is a polyethylene of the Polywax 2000™ type having a fusion temperature of approximately from 112° Celsius to 120° Celsius,
the phase change material is a mineral material,
the mineral material is magnesium chloride hexahydrate having a fusion temperature of approximately 116° Celsius,
the hot source comprises a control loop and the installation comprises remote control means for the control loop,
the hot source comprises a storage tank for discharging the first transport circuit for the first heat-exchange fluid,
the hot source comprises a thermal energy generator in order to ensure permanent production of electricity when the storage means are empty and solar energy is insufficient,
the hot source comprises a thermal energy recovery means in order to ensure permanent production of electricity when the storage means are empty and solar energy is insufficient,
the heating means comprise vacuum tube solar captors having an operating temperature which is particularly between 80° Celsius and 150° Celsius,
the maximum temperature of the first heat-exchange fluid is 150° Celsius,
the maximum pressure in the first transport circuit is 6 bar,
the first transport circuit comprises two independent sub-circuits, the first sub-circuit connecting the heating means to the storage means, the second sub-circuit connecting the storage means to the heat machine for producing electricity,
the heat machine comprises:
   a third transport circuit for a service fluid,
   a heater for changing the service fluid from the liquid state to the gaseous state using the hot source,
   a turbine which operates using the service fluid in the gaseous state and which is connected to an electricity generator,
   a condenser for changing the service fluid from the gaseous state to the liquid state using the cold source, and the maximum temperature of the service fluid in the turbine is 100° Celsius,
the service fluid is an organic fluid, in particular butane.

### BRIEF DESCRIPTION OF THE DRAWINGS

The invention and its advantages will be better understood from a reading of the following description which is given purely by way of example and with reference to the appended drawings, in which:

FIG. 1 is a schematic illustration of the installation according to the invention,

FIG. 2 is a view similar to FIG. 1 of the installation in accordance with a different embodiment of the invention.

### DETAILED DESCRIPTION OF THE PREFERRED EMBODIMENTS

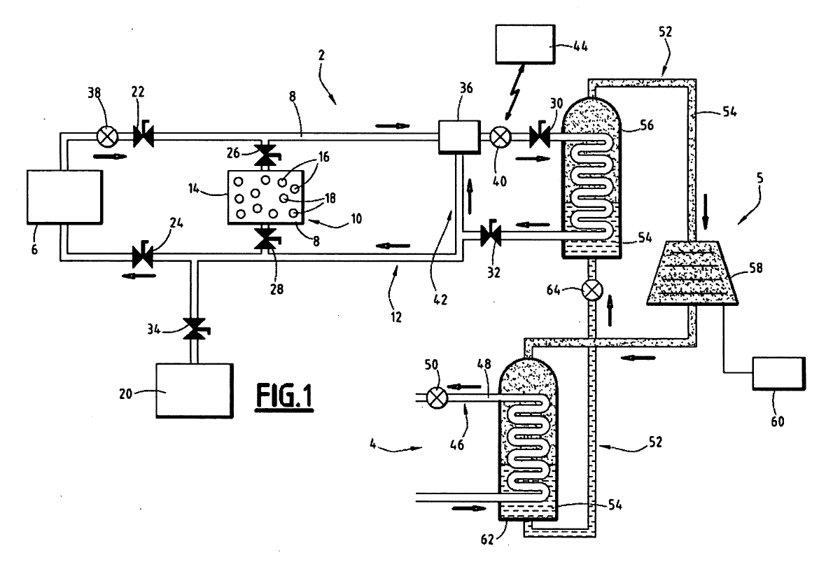

In FIG. 1, an installation for generating electrical energy from solar energy comprises a hot source 2, a cold source 4 and a heat machine 5 for producing electricity.

The hot source 2 comprises means 6 for heating a first heat-exchange fluid 8 by means of solar energy, means 10 for storing thermal energy and a first transport circuit 12 for the first heat-exchange fluid 8.

The first circuit 12 connects the heating means 6, the storage means 10 and the heat machine 5 for producing electricity. The first fluid 8 is water.

The heating means 6 comprise a plurality of vacuum tube solar captors which are not illustrated.

Each vacuum tube captor comprises a reflector and two concentric glass tubes which are closed in a semi-circular manner at one end and which are sealed hermetically with respect to each other at the other end.

The two concentric glass tubes are separated by a vacuum. The outer surface of the inner tube is covered with a coating which absorbs solar radiation. The coating is, for example, constructed from powdered aluminium nitrite.

There is, in each inner tube, a “U”-shaped pipe which conveys the first heat-exchange fluid 8 and which is connected to the first circuit 12.

The operating temperature of the vacuum tube solar captors is between 80° Celsius and 150° Celsius.

The storage means 10 comprise a vessel 14 and a plurality of sealed capsules 16 which are arranged in the vessel 14. A phase change material 18 (PCM) which is also referred to as a state change material is provided in the sealed capsules 16. The first heat-exchange fluid 8 flows in the vessel 14 around the capsules 16.

The fusion temperature of the phase change material 18 is between 100° Celsius and 130° Celsius. The phase change material is, for example, an organic material such as polyethylene of the Polywax 2000™ type having a fusion temperature in the order of from 112° Celsius to 120° Celsius, or a mineral material, such as magnesium chloride hexahydrate (MgCl₂, 6H₂O) having a fusion temperature in the order of 116° Celsius.

The phase change material will be selected in accordance with its environmental friendliness (recyclability, analysis of the life cycle, etc.).

The use of such a phase change material for an installation for generating electrical energy having a power which is substantially equal to 1 MW will ensure various scenarios, and accordingly the energy levels stored will be between 5 MWh and 100 MWh.

The hot source 2 comprises a storage tank 20 for discharging the first transport circuit 12 for the first heat-exchange fluid 8.

The first circuit 12 comprises a plurality of valves 22, 24, 26, 28, 30, 32, 34 and a mixer 36. The whole of the flow of the first fluid 8 in the first circuit 12 is brought about by two pumps 38, 40.

In the first circuit 12, the first heat-exchange fluid 8 is at a maximum temperature of 150° Celsius and under a maximum pressure of 6 bar.

The storage means 10 and the first circuit 12 are heat-insulated by an insulator which is not illustrated.

The hot source 2 comprises a control loop 42 which comprises a mixer 36 and the pump 40. The installation comprises remote control means 44 for the loop 42.

The cold source 4 comprises a second transport circuit 46 for a second heat-exchange fluid 48. The flow of the second fluid 48 in the second circuit 46 is brought about by a pump 50. The second fluid 46 is water, taken, for example, from a river or a sea and discharged back into the river or sea, respectively.

The heat machine 5 comprises a third transport circuit 52 for a service fluid 54, a heater 56, a turbine 58 which is connected to an electricity generator 60, and a condenser 62.

The flow of the service fluid 54 in the third circuit 52 is brought about by a pump 64. The service fluid 54 is an organic fluid, such as butane or propane, preferably butane. The boiling temperature of the service fluid 54 is substantially low and in the order of 80° Celsius at a pressure of 9.6 bar.

The heater 56 is intended to change the service fluid 54 from the liquid state to the gaseous state from the hot source 2. The first circuit 12 of the hot source is in the form of a winding inside the heater 56, the winding being in contact with the service fluid 54. The service fluid 54 is under a pressure of approximately 11 bar in the heater 56. At the outlet of the heater 56, the service fluid 54 is in the gaseous state, at a temperature of approximately 85° Celsius and under a pressure of approximately 11 bar.

The turbine 58 conventionally comprises a rotor which comprises a shaft, to which vanes are fixed, and a stator which comprises a housing which carries fixed deflectors. At the outlet of the turbine 58, the service fluid 54 is in the gaseous state, at a temperature of approximately 40° Celsius under a pressure of between 2 and 3 bar. The turbine 58 is intended to convert the energy resulting from the pressure reduction of the service fluid 54 in the gaseous state into mechanical energy.

The electricity generator 60 converts the mechanical energy received from the turbine 58 into electrical energy.

The condenser 62 is intended to change the service fluid 54 from the gaseous state to the liquid state, from the cold source 4. The third circuit 46 of the cold source is in the form of a winding inside the condenser 62, the winding being in contact with the service fluid 54. At the outlet of the condenser 62, the service fluid 54 is in the liquid state.

The operation of the installation for generating electrical energy will now be described with reference to FIG. 1.

The installation for generating electrical energy is referred to as a low-temperature installation, given that the maximum temperature of the hot source is 150° Celsius which is distinctly less than the temperature used in other thermal solar stations, such as cylindro-parabolic captor stations, tower type stations, parabolic captor type stations, where the temperature of the heat-exchange fluid flowing in the hot source is greater than 400° Celsius.

The solar captors of the heating means 6 capture, during the day, solar radiation and the solar energy is transmitted to the first heat-exchange fluid 8 in the form of thermal energy. The storage means 10 serve as a buffer between the thermal energy produced by the heating means 6 and that consumed by the heat machine 5 for producing electricity. The storage means 10 therefore allow the electricity production to be decoupled from solar availability.

A plurality of operating modes may be envisaged in terms of the hot source 2, by means of the valves 22 to 32, the mixer 36 and the pumps 38 and 40: storage of thermal energy only, direct production of thermal energy, storage and production of thermal energy, reclaiming of thermal energy and direct production of thermal energy, and reclaiming of thermal energy only.

For storing thermal energy only, the valves 22 to 28 are open and the intake of water from the pump 38 is stopped at the mixer 36, the pump 40 not operating.

For directly producing thermal energy, the valves 22, 24, 30, 32 are open and the valves 26 and 28 are closed. The control means 44 act remotely on the control loop 42, in particular by means of the mixer 36 and the pump 40. Depending on the control, the flow of the pump 40 is substantially equal to or far greater than the flow of the pump 38.

For storing and producing thermal energy, the valves 22 to 32 are open and the flow of the pump 38 is greater than the flow of the pump 40.

For reclaiming thermal energy and producing thermal energy, all the valves 22 to 32 are open and the flow of the pump 40 is greater than the flow of the pump 38.

For reclaiming thermal energy only, the valves 22, 24 are closed and the valves 26 to 32 are open. In that case, the pump 38 does not operate.

It should be noted that the valve 34 may be open if necessary in order to relieve the first circuit 12 by discharging water 8 into the tank 20, in particular when the temperature of the water 8 is excessively high.

The storage means 10 use the latent fusion heat of the phase change material 18. The water 8 flows between the sealed capsules 16 and transmits heat to them in order to progressively change the material 18 from the solid state to the liquid state when the temperature of the water 8 is substantially greater than the fusion temperature of the material 18. The material 18 is selected so as to be appropriate for the maximum temperature permitted by the hot source 2. The fusion temperature of the phase change material 18 which is between 100° Celsius and 130° Celsius is thus substantially less than the maximum temperature of the first heat-exchange fluid 8, that is to say, 150° Celsius.

When the temperature of the water 8 decreases and becomes less than the solidification temperature of the phase change material 18, the material 18 progressively changes back from the liquid state to the solid state. The solidification of the material 18 releases heat, which corresponds to reclaiming thermal energy.

The control loop 42 allows adaptation of the quantity of thermal energy provided by the hot source 2 to the heat machine 5 for producing electricity.

Owing to the heat supplied by the hot source 2, the service fluid 54 changes from the liquid state to the gaseous state in the heater 56. The service fluid 54 thus arrives, in the gaseous state and at a pressure of 11 bar, at the inlet of the turbine 58. The service fluid in the gaseous state undergoes pressure reduction in the turbine 58 and provides mechanical energy, rotating the rotor of the turbine. This mechanical energy is transmitted to the generator 60 in order to produce electricity. At the outlet of the turbine 58, the service fluid 54 is still in the gaseous state, but at a distinctly lower pressure.

The service fluid 54 then changes back to the liquid state in the condenser 62 upon contact with the cold source 4. At the outlet of the condenser 62, the service fluid 54 in the liquid state is conveyed by the pump 64 in order to return to the inlet of the heater 56 and again to exploit the heat supplied by the source 2.

In this manner, the storage of thermal energy at the hot source 2 allows random climatic variations to be attenuated and the operation of the installation for generating electrical energy to be optimised.

The storage of thermal energy, which uses the latent fusion heat of a phase change material, further has the advantage, over storage of thermal energy using sensible heat, of ensuring a high density of storage and a substantially constant temperature.

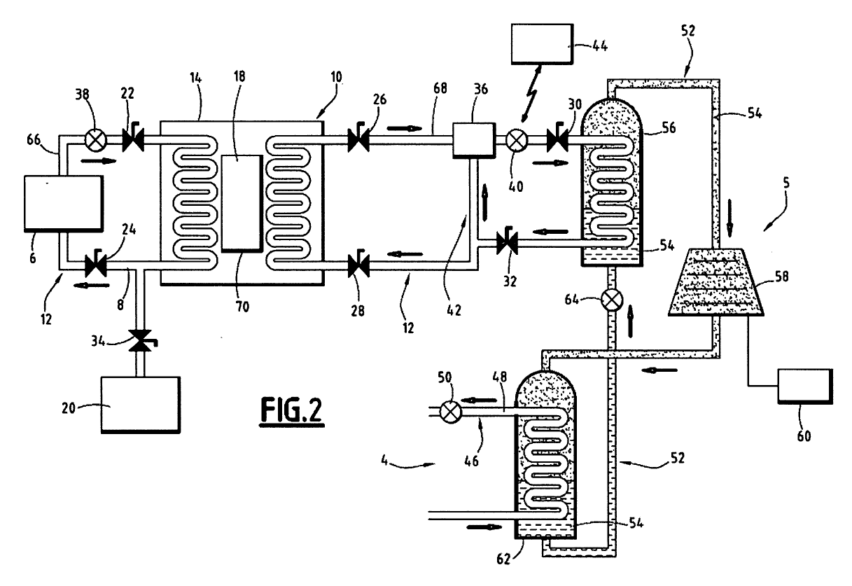

FIG. 2 illustrates another embodiment, for which elements similar to the embodiment described above are referred to with the same reference numerals.

The first circuit 12 of the hot source 2 comprises two independent sub-circuits 66, 68.

The first sub-circuit 66 connects the heating means 6 to the storage means 10 and the second sub-circuit 68 connects the heating means 10 to the heat machine 5 for producing electricity.

The phase change material 18 is stored in a vessel 70 which is surrounded by the winding-like sub-circuits 66, 68. The vessel 70 and the windings of the sub-circuits 66, 68 are arranged inside the vessel 14. The vessel 14 and the sub-circuits 66, 68 are heat-insulated with an insulator which is not illustrated.

The operation of the second embodiment is substantially identical to that of the first embodiment which is described above by means of FIG. 1. Only the operational differences in relation to the first embodiment are described hereinafter with reference to FIG. 2.

The hot source 2 provides two operating modes, carried out in a simultaneous or successive manner: the storage of thermal energy and the retrieval of thermal energy.

For storing thermal energy, the valves 22 and 24 are open and the pump 38 causes a flow of water 8 in the first sub-circuit 66.

For retrieving thermal energy, the valves 26, 28, 30, 32 are open and the flow of water 8 is brought about by the pump 40 in the second sub-circuit 68. The control means 40 further act on the control loop 42.

The operation of the heat machine 5 for producing electricity in the second embodiment is identical to that described in the first embodiment and is not therefore described again.

By way of a variant, the service fluid 54 is propane.

In addition, the hot source 2 may also comprise a generator or a means for recovering thermal energy at 100° Celsius in order to ensure permanent production of electricity, in particular when the storage means 10 are empty and solar energy is insufficient, for example, at night.

1. Installation for generating electrical energy from solar energy, of the type comprising:
a hot source,
a cold source,
a heat machine for producing electricity, using the hot source and the cold source;
the hot source comprising:
means for heating a first heat-exchange fluid using solar energy,
means for storing thermal energy,
a first transport circuit for the first heat-exchange fluid connecting the heating means, the storage means and the heat machine for producing electricity;
the cold source comprising a second transport circuit for a second heat-exchange fluid;
wherein the storage means comprise a phase change material, the fusion of the phase change material being capable of storing heat and the solidification of the phase change material being capable of releasing the heat which is previously stored.

2. Installation according to claim 1, wherein the storage means comprise a vessel and a plurality of sealed capsules which are arranged in the vessel, the first heat-exchange fluid flowing in the vessel between the sealed capsules, the sealed capsules comprising the phase change material.

3. Installation according to claim 1, wherein the fusion temperature of the phase change material is between 100° Celsius and 130° Celsius.

4. Installation according to claim 1, wherein the phase change material is an organic material.

5. Installation according to claim 4, wherein the organic material is a polyethylene of the Polywax 2000™ type having a fusion temperature of approximately from 112° Celsius to 120° Celsius.

6. Installation according to claim 1, wherein the phase change material is a mineral material.

7. Installation according to claim 6, wherein the mineral material is magnesium chloride hexahydrate having a fusion temperature of approximately 116° Celsius.

8. Installation according to claim 1, wherein the storage means are arranged in the first circuit parallel with the heating means and the heat machine.

9. Installation according to claim 1, wherein the hot source comprises a control loop and the installation comprises remote control means for the control loop.

10. Installation according to claim 1, wherein the hot source comprises a storage tank for discharging the first transport circuit for the first heat-exchange fluid.

11. Installation according to claim 1, wherein the hot source comprises a thermal energy generator in order to ensure permanent production of electricity when the storage means are empty and solar energy is insufficient.

12. Installation according to claim 1, wherein the hot source comprises a thermal energy recovery means in order to ensure permanent production of electricity when the storage means are empty and solar energy is insufficient.

13. Installation according to claim 1, wherein the heating means comprise vacuum tube solar captors having an operating temperature which is particularly between 80° Celsius and 150° Celsius.

14. Installation according to claim 1, wherein the maximum temperature of the first heat-exchange fluid is 150° Celsius.

15. Installation according to claim 1, wherein the maximum pressure in the first transport circuit is 6 bar.

16. Installation according to claim 1, wherein the first transport circuit comprises two independent sub-circuits, the first sub-circuit connecting the heating means to the storage means, the second sub-circuit connecting the storage means to the heat machine for producing electricity.

17. Installation according to claim 1, the heat machine comprising:
a third transport circuit for a service fluid,
a heater for changing the service fluid from the liquid state to the gaseous state using the hot source,
a turbine which operates using the service fluid in the gaseous state and which is connected to an electricity generator,
a condenser for changing the service fluid from the gaseous state to the liquid state using the cold source,
wherein the maximum temperature of the service fluid in the turbine is 100° Celsius.

18. Installation according to claim 17, wherein the service fluid is an organic fluid, in particular butane.

19. Method for generating electrical energy from solar energy comprising:
heating a first heat-exchange fluid using solar energy by means of solar heating means,
transporting the first heat-exchange fluid in a first circuit from the heating means towards thermal energy storage means comprising a phase change material and/or towards a heat machine for producing electricity,
generating electrical energy by means of the heat machine from the thermal energy which is transported by means of the first heat-exchange fluid,
storing thermal energy via the fusion of the phase change material when the thermal energy from the heating of the first fluid is greater than that necessary for generating electrical energy and
reclaiming thermal energy via the solidification of the phase change material when the thermal energy from the heating of the first fluid is less than that necessary for generating electrical energy.

20. Method according to claim 19, wherein it is carried out in an installation for generating electrical energy according to claim 1.
